(19) United States
(12) Patent Application Publication
(10) Pub. No.: US 2026/0018331 A1
(43) Pub. Date: Jan. 15, 2026

(54) WINDING COMPONENT AND POWER SUPPLY DEVICE

(71) Applicant: TDK CORPORATION, Tokyo (JP)

(72) Inventor: Junpei SAWAYAMA, Tokyo (JP)

(73) Assignee: TDK CORPORATION, Tokyo (JP)

(21) Appl. No.: 19/262,737

(22) Filed: Jul. 8, 2025

(30) Foreign Application Priority Data
Jul. 9, 2024 (JP) 2024-110318

(51) Int. Cl. H01F 27/32; H01F 27/28

(52) U.S. Cl. CPC H01F 27/325; H01F 27/2847; H01F 27/2895

(57) ABSTRACT

The positioning can be performed at a plurality of positions by the first positioning mechanism and the second positioning mechanism. Further, the second positioning mechanism has a hole portion for receiving the second engaging portion as the second locking portion. By engaging the second engaging portion with the hole portion, the second positioning mechanism can restrict the displacement between the bobbin and the coil over the entire circumference. Thus, the bobbin and the coil can be accurately positioned. On the other hand, the first positioning mechanism includes a guide portion for relatively guiding the first engaging portion to the first locking portion along the insertion direction when the coil is inserted into the bobbin. Therefore, when the coil is inserted into the bobbin, the coil can be easily positioned only by moving the coil along the guide portion.

### CROSS-REFERENCE TO RELATED APPLICATIONS

This application is based upon and claims the benefit of priority from Japanese Patent Applications No. 2024-110318, filed on 9 Jul. 2024, the entire content of which is incorporated herein by reference.

### TECHNICAL FIELD

The present disclosure relates to a winding component and a power supply device.

### BACKGROUND

Known in the art is a winding component including a bobbin body insertable inside a winding, a protrusion protruding from an outer surface of the bobbin body enable to be interposed between turns of the winding, and locking means to prevent rotation of the bobbin (for example, Japanese Patent Application Publication No. 2005-217311). In this winding component, the protrusion is dropped into a slit, then the bobbin body is rotated to turn the protrusion so that the protrusion interposes between the turns of the winding and thereby positions the winding.

### SUMMARY

In the above winding component, because the bobbin body must be rotated to fix and position the coil, manufacturing involves extra steps. Omitting these steps, however, it is likely not to position accurately the bobbin relative to the coil. Accordingly, it has been desired to achieve both ease of manufacture and precise positioning of the bobbin and the coil.

According to an aspect of the present disclosure, there is provided a winding component and a power supply device that enable easy manufacture while precisely positioning the bobbin and the coil.

A winding component according to one embodiment of the present disclosure includes a core, a plate-shaped coil provided with regard to the core, a bobbin housing the coil, and a first positioning mechanism and a second positioning mechanism for positioning the bobbin and the coil relative to each other. The bobbin has an opening, the coil is insertable in an insertion direction through the opening in manufacturing. The first positioning mechanism has a first locking portion provided on one of the bobbin and the coil and a first engaging portion provided on the other of the bobbin and the coil and engaging the first locking portion. The second positioning mechanism has a second locking portion provided on one of the bobbin and the coil and a second engaging portion provided on the other of the bobbin and the coil and engaging the second locking portion. The first positioning mechanism further has a guide portion guiding the first engaging portion along the insertion direction toward the first locking portion when the coil is inserted into the bobbin. The second positioning mechanism has a hole portion receiving the second engaging portion, as the second locking portion.

In the winding component according to one embodiment of the present disclosure, the first positioning mechanism has the first locking portion provided on one of the bobbin and the coil and the first engaging portion provided on the other of the bobbin and the coil and engaging the first locking portion. Thus, positioning by the first positioning mechanism is achieved by engagement of the first engaging portion with the first locking portion. The second positioning mechanism has the second locking portion provided on one of the bobbin and the coil and the second engaging portion provided on the other of the bobbin and the coil and engaging the second locking portion. Thus, positioning by the second positioning mechanism is achieved by engagement of the second engaging portion with the second locking portion. Therefore, positioning can be performed at a plurality of positions by the first positioning mechanism and the second positioning mechanism. Further, the second positioning mechanism has a hole portion as the second locking portion receiving the second engaging portion. By engaging the second engaging portion with the hole portion, the second positioning mechanism can restrict the displacement between the bobbin and the coil over the entire circumference. Thus, the bobbin and the coil can be accurately positioned. On the other hand, the first positioning mechanism includes a guide portion relatively guiding the first engaging portion to the first locking portion along the inserting direction when the coil is inserted into the bobbin. Therefore, when the coil is inserted into the bobbin, the coil can be easily positioned only by moving the coil along the guide portion. As described above, the bobbin and the coil can be accurately positioned while enabling easy manufacturing.

The guide portion of the first positioning mechanism may have a groove shape extending in the insertion direction. In this case, the first engaging portion is smoothly guided along the groove shape in the insertion direction, hence it enables the coil to insert easily into the bobbin.

The first engaging portion may be provided on lower side in the insertion direction relative to the second engaging portion. In this case, when the coil is inserted into the bobbin, the first engaging portion precedes the second engaging portion and is guided by the guide portion. As a result, the positioning by the second positioning mechanism can be performed smoothly in addition to the smooth positioning by the first positioning mechanism. Further, it is possible to shorten the moving distance of the second engaging portion from the point where the bobbin and the coil overlap at the second engaging portion to the point where the second engaging portion reach the hole portion of the second locking portion. Therefore, the distortion of the bobbin and the coil can be reduced.

The first engaging portion may be at least one first protruding portion provided on the coil and received by the second locking portion of the bobbin, and the second engaging portion may be a second protruding portion provided on the coil and received by the hole portion serving as the second locking portion of the bobbin. Since the first engaging portion and the second engaging portion are both the first protruding portion and the and second protruding portion provided on the coil, the guide portion and the hole portion can be provided on the bobbin having a high degree of freedom in shape. Further, since the first engaging portion is the first protruding portion, the guide can be smoothly guided with a simple structure. Since the second engaging portion is the second protruding portion, the second engaging portion can be smoothly inserted into the hole portion of the second engaging portion. Therefore, the coil can be easily inserted into the bobbin.

The first protruding portion and the second protruding portion may be provided on one main surface side of the coil, the first protruding portion may have a height lower than a height of the second protruding portion. In this case, the first protruding portion can be prevented from interfering with the structure in the vicinity of the second locking portion for engaging with the second protruding portion. Therefore, the coil can be easily inserted into the bobbin. Also, the distortion of the bobbin and the coil can be reduced.

The hole portion serving as the second locking portion may be located at a position higher than the first locking portion receiving the first protruding portion. In this case, it is possible to prevent the first protruding portion from being erroneously inserted into the hole portion serving as the second locking portion. Therefore, the coil can be easily inserted into the bobbin. Further, by suppressing the interference between the first protruding portion and the hole portion, the distortion of the bobbin and the coil can be reduced.

In a plan view, a diameter of the first protruding portion may be larger than a diameter of the second protruding portion. In this case, erroneous insertion into the hole portion of the second locking portion can be suppressed. Therefore, the coil can be easily inserted into the bobbin.

An inclined portion may be formed at the opening of the bobbin. In this case, at the opening of the bobbin, the first engaging portion and the second engaging portion are smoothly guided in the insertion direction by the inclined portion. Therefore, the coil can be easily inserted into the bobbin. Also, the distortion of the bobbin and the coil can be reduced by the smooth insertion.

The first locking portion and the second locking portion may be arranged parallel to the insertion direction. In this case, when inserting the coil into the bobbin, the coil can be easily inserted into the bobbin by positioning the first locking portion and the second locking portion so that they are aligned in parallel with the insertion direction.

The first positioning mechanism may have a slit, as the guide portion, opening toward the insertion direction, and the slit may have a taper portion widening on a side into which the first engaging portion is inserted. In this case, the taper portion of the slit can receive the first engaging portion inserted and guide the first engaging portion to the first locking portion. Therefore, the coil can be easily inserted into the bobbin. Also, the distortion of the bobbin and the coil can be reduced by the smooth insertion.

The bobbin may have a protrusion receiving portion extending in the insertion direction on a side opposite to the opening in the insertion direction, the coil may have a protruding slip portion extending in the insertion direction at a lower end in the insertion direction, and movement of the coil in a direction orthogonal to the insertion direction relative to the bobbin may be restricted by the protruding slip portion being received in the protrusion receiving portion. In this case, when the coil is inserted into the bobbin, the coil can be inserted while being guided by the protrusion receiving portion in a state where the protruding slip portion is inserted into the protrusion receiving portion. Therefore, the coil can be easily inserted into the bobbin. Also, the protruding slip portion can have a heat radiation function of the coil.

A power supply device according to one embodiment comprises the above winding component and a base plate supporting the winding component. The winding component may be used in a voltage conversion circuit.

According to the above power supply device, the winding component described above can be suitably used in the power supply device.

The coil may have a protruding slip portion extending in the insertion direction at a lower end in the insertion direction, and the protruding slip portion may be thermally connected to the base plate. In this case, the heat of the coil can be suitably radiated through the protruding slip and the base plate.

### BRIEF DESCRIPTION OF THE DRAWINGS

FIG. 1 is a side view of a power supply device including a winding component according to one embodiment of the present disclosure.

FIG. 2 is a perspective view of the winding component according to the embodiment of the present disclosure.

FIG. 3 is an exploded perspective view according to the winding component.

FIG. 4 is a plan view of the winding component.

FIG. 5 is a cross-sectional perspective view of the first engaging portion and the vicinity of the first engaging portion.

FIG. 6 is a cross-sectional perspective view of the second engaging portion and the vicinity of the second engaging portion.

FIG. 7 is a cross-sectional view taken along line VII-VII of FIG. 4.

FIG. 8 is a developed perspective view showing a modified winding component.

FIG. 9 is a developed perspective view showing a modified winding component.

FIG. 10 is a developed perspective view showing a modified winding component.

FIG. 11 is a developed perspective view showing a modified winding component.

FIG. 12 is a developed perspective view showing a modified winding component.

### DETAILED DESCRIPTION

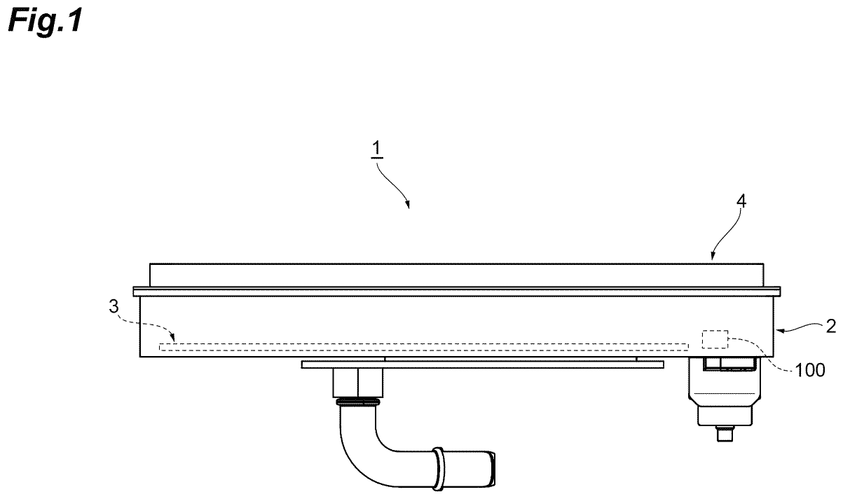

With reference to FIG. 1, a power supply device 1 including a winding component 100 according to the present embodiment is described. FIG. 1 is a side view of the power supply device 1 including the winding component 100. As shown in FIG. 1, the power supply device 1 includes the winding component 100, a base plate 2, a substrate 3, and a lid body 4. The power supply device 1 is assembled by fitting the lid body 4 onto the base plate 2 in a state where the substrate 3 is housed. The base plate 2 may be made of a die-cast alloy or the like. The power supply device 1 may be a unit including, for example, an AC/DC power supply or a DC/DC converter. The winding component 100 is provided in the power supply device 1. The base plate 2 supports the winding component 100 in the power supply device 1. The power supply device 1 uses the winding component 100 as a voltage-conversion circuit. The overall shape of the power supply device 1 is not limited to that shown in FIG. 1. The position of the winding component 100 in the power supply device 1 is not particularly limited. The application of the winding component 100 is not particularly limited, and the winding component 100 may be used for other than a voltage conversion circuit.

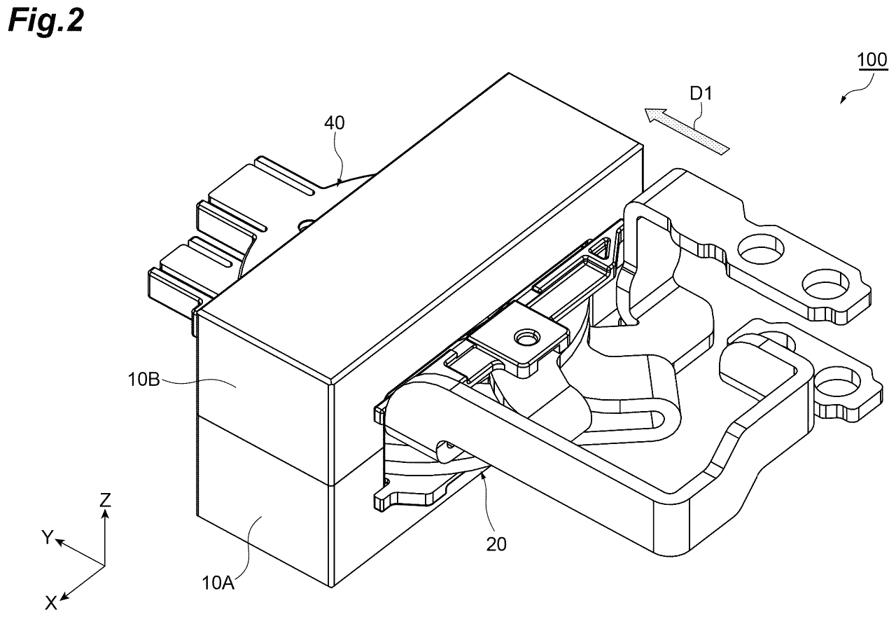

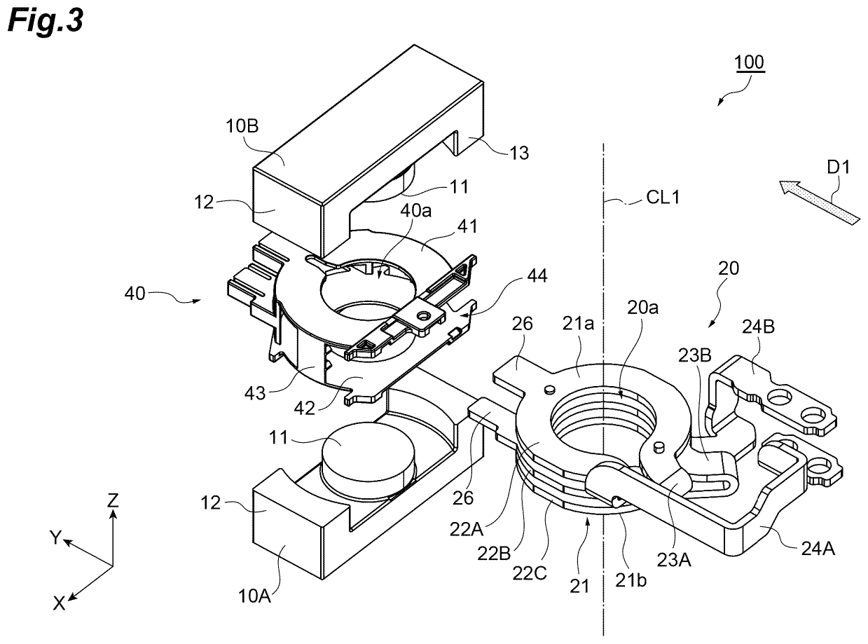

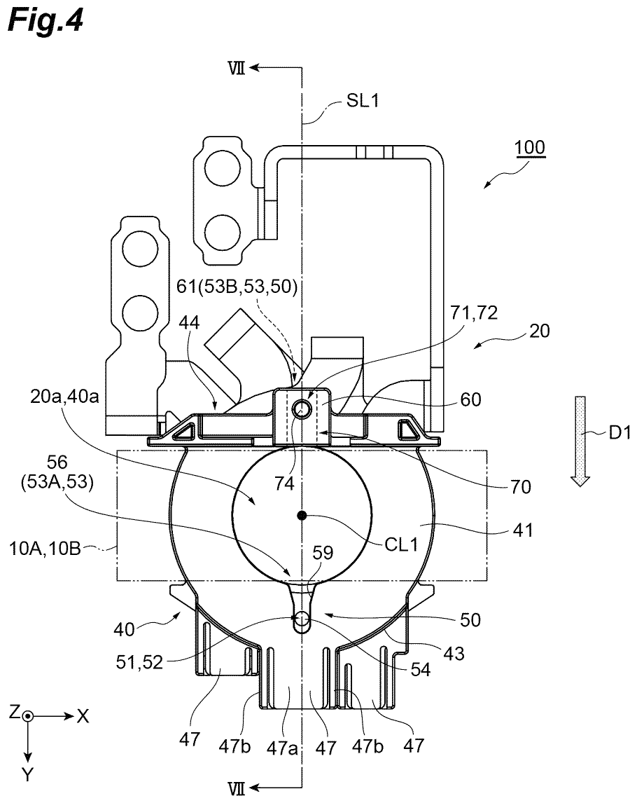

With reference to FIGS. 2 to 4, the structure of the winding component 100 is described. FIG. 2 is a perspective view of the winding component 100 according to the embodiment of the present disclosure. FIG. 3 is a developed perspective view of the winding component 100. FIG. 4 is a plan view of the winding component 100. The cores 10A and 10B are shown in imaginary lines in FIG. 4. The X-axis direction and the Y-axis direction are set and shown with respect to the bottom surface of the base plate 2 and the direction in which the substrate 3 (see FIG. 1) extends. The Z-axis direction is set to the bottom surface of the base plate 2 and the thickness direction of the substrate 3. In the present specification, the upper side is defined as the positive side in the Z-axis direction, and the lower side is defined as the negative side in the Z-axis direction. In the present specification, for convenience of description, words such as “up” and “down” may be used, but these do not limit the posture of the power supply device 1 and the winding component 100 during use. In the present embodiment, the coil 20 is inserted into the bobbin 40 at the time of manufacturing. In the present specification, a direction parallel to the insertion direction D1 is defined as a Y-axis direction, a lower side of the insertion direction D1 is defined as a positive side of the Y-axis direction, and an upper side is defined as a negative side of the Y-axis direction. As shown in FIGS. 2 to 4, the winding component 100 includes cores 10A and 10B, a coil 20, and a bobbin 40.

The cores 10A and 10B are members formed of magnetic material. The core 10A is disposed below the coil 20; the core 10B is disposed above the coil 20. The cores 10A and 10B include a protruding portion 11 accommodated in a circular penetration portion 20a formed in the center of the coil 20, and protruding portions 12 and 13 disposed on both end sides in the X-axis direction outside the coil 20 (see FIG. 3). The cores 10A and 10B are formed as rectangular parallelepiped members which sandwich parts of the coil 20 and the bobbin 40 in the vicinity of the central position from the vertical direction.

As shown in FIG. 3 the coil 20 is a flat conductor forming a spring portion 21 by being wound in an annular shape around axis CL1. The coil 20 is formed of a metallic material such as copper. As described above, the coil 20 is provided for the cores 10A and 10B (see FIG. 2). The spring portion 21 has flat plate-like winding portions 22A, 22B, and 22C which are wound substantially one round. The winding portions 22A, 22B, and 22C are arranged so as to face each other in a state of being spaced apart from each other in the vertical direction in order from the top. The coil 20 has a central penetration portion 20a inside of the winding portions 22A, 22B, and 22C. The upper surface of the winding portion 22A becomes the upper main surface 21a of the spring portion 21. The lower surface of the winding portion 22C serves as the lower main surface 21b of the spring portion 21.

The uppermost winding portion 22A and the second winding portion 22B from the top are electrically connected via a flat plate-shaped relay portion 23A. The second winding portion 22B from the top and the lowest winding portion 22C are electrically connected via a flat plate-shaped relay portion 23B. The relay portions 23A and 23B are provided on the outer peripheral side of the spring portion 21 on the upper side in the insertion direction D1 with respect to the winding portions 22A, 22B, and 22C. Thus, the coil 20 has the spring portion 21 which is wound three times. The number of turns of the spring portion 21 is not limited, and may be two or four or more. The coil 20 has flat plate-shaped bus bars 24A and 24B extending from both ends of the winding of the spring portion 21. The bus bars 24A, 24B are provided on the upper side of the winding portions 22A, 22B, and 22C in the insertion direction D1 so as to extend to the outer peripheral side of the spring portion 21.

As shown in FIG. 3, the bobbin 40 is a member for accommodating the coil 20. The bobbin 40 is formed of a resin material. The bobbin 40 includes an upper wall portion 41, a lower wall portion 42, and a peripheral wall portion 43. The upper wall portion 41 is an annular flat plate member that covers the spring portion 21 from above. The lower wall portion 42 is an annular flat plate member that covers the spring portion 21 from below. The upper wall portion 41 and the lower wall portion 42 are opposed to each other in a state of being separated from each other in the vertical direction. A circular penetration portion 40a coaxial with the penetration portion 20a of the coil 20 is provided inside of the upper wall portion 41 and the lower wall portion 42. The projecting portions 11 of the cores 10A and 10B are inserted into the penetration portion 40a and the penetration portion 20a. The peripheral wall portion 43 is a wall portion extending in the vertical direction at the outer peripheral edge of the upper wall portion 41 and the lower wall portion 42. The peripheral wall portions 43 are provided on both end sides in the X-axis direction and on the lower side in the insertion direction D1.

An internal space surrounded by the upper wall portion 41, the lower wall portion 42, and the peripheral wall portion 43 serves as a housing space for the spring portion 21. The bobbin 40 has an opening 44 which opens on the upper side in the insertion direction D1 of the internal space. The opening 44 is a portion into which the coil 20 can be inserted in the insertion direction D1 at the time of manufacturing. At the opening 44, the edges on the upper side in the insertion direction D1 of the upper wall portion 41 and the lower wall portion 42 are cut out to extend substantially linearly in parallel with the X-axis direction.

The procedure of manufacturing the winding component 100 configured as described above will be described. First, a portion on the lower side in the insertion direction D1 of the coil 20 is disposed so as to face the opening 44 of the bobbin 40. The coil 20 is moved (relatively) to the bobbin 40 in the insertion direction D1. Thus, the coil 20 is accommodated in the internal space of the bobbin 40 through the opening 44. The coil 20 is inserted to a position where the penetration portion 20a is substantially coaxial with the penetration portion 40b of the bobbin 40 (see FIG. 4). When the coil 20 is received in the bobbin 40, the cores 10A and 10B are attached to the assembly. The projecting portions 11 of the cores 10A and 10B are inserted into the penetration portion 20a and the penetration portion 40a, and the coil 20 and the bobbin 40 are sandwiched by the cores 10A and 10B from above and below. This completes the manufacture of the winding component 100.

As shown in FIG. 4, the winding component 100 includes a first positioning mechanism 50 and a second positioning mechanism 70. The first positioning mechanism 50 and the second positioning mechanism 70 are mechanisms for positioning between the bobbin 40 and the coil 20. The first positioning mechanism 50 has a first locking portion 51 provided on one of the bobbin 40 and the coil 20 and a first engaging portion 52 provided on the other of the bobbin 40 and the coil 20. The first locking portion 51 is a portion that receives the first engaging portion 52 when the positioning is completed. The first engaging portion 52 is a portion to be engaged with the first locking portion 51 when positioning is completed. The second positioning mechanism 70 has a second locking portion 71 provided on one of the bobbin 40 and the coil 20, and a second engaging portion 72 provided on the other of the bobbin 40 and the coil 20. The second locking portion 71 is a portion for receiving the second engaging portion 72 when the positioning is completed. The second engaging portion 72 is a portion to be engaged with the second locking portion 71 when positioning is completed.

In the present embodiment, the bobbin 40 is provided with the first locking portion 51, the coil 20 is provided with the first engaging portion 52, the bobbin 40 is provided with the second locking portion 71, and the coil 20 is provided with the second engaging portion 72. However, the combination is not limited to this. For example, the bobbin 40 may be provided with the first locking portion 51, the coil 20 may be provided with the first engaging portion 52, the coil 20 may be provided with the second locking portion 71, and the bobbin 40 may be provided with the second engaging portion 72. The coil 20 may be provided with the first locking portion 51, the bobbin 40 may be provided with the first engaging portion 52, the bobbin 40 may be provided with the second locking portion 71, and the coil 20 may be provided with the second engaging portion 72. The coil 20 may be provided with the first locking portion 51, the bobbin 40 may be provided with the first engaging portion 52, the coil 20 may be provided with the second locking portion 71, and the bobbin 40 may be provided with the second engaging portion 72.

The first locking portion 51 and the first engaging portion 52 of the first positioning mechanism 50 and the second locking portion 71 and the second engaging portion 72 of the second positioning mechanism 70 are disposed at positions different from each other in the circumferential direction around the axis CL1 of the coil 20. In the present embodiment, the first locking portion 51 and the first engaging portion 52 of the first positioning mechanism 50 and the second locking portion 71 and the second engaging portion 72 of the second positioning mechanism 70 are disposed at positions at 180° from each other around the axis CL1. Further, the first locking portion 51 and the first engaging portion 52 of the first positioning mechanism 50 are disposed on the lower side in the insertion direction D1, and the second locking portion 71 and the second engaging portion 72 of the second positioning mechanism 70 are disposed on the upper side in the insertion direction

D1. In a plan view, a reference line SL1 passing through the axis CL1 and parallel to the insertion direction D1 is set. At this time, the first locking portion 51 and the first engaging portion 52 of the first positioning mechanism 50 and the second locking portion 71 and the second engaging portion 72 of the second positioning mechanism 70 are disposed on the reference line SL1 in a plan view. However, the angle formed around the axis CL1 by the first locking portion 51 and the first engaging portion 52 of the first positioning mechanism 50 and the second locking portion 71 and the second engaging portion 72 of the second positioning mechanism 70 is not particularly limited, and the first locking portion 51 and the first engaging portion 52 of the first positioning mechanism 50 and the second locking portion 71 and the second engaging portion 72 of the second positioning mechanism 70 may be disposed at any position as long as the displacement between the bobbin 40 and the coil 20 after the completion of manufacturing can be suppressed. Also, when the first locking portion 51 and the first engaging portion 52 of the first positioning mechanism 50 and the second locking portion 71 and the second engaging portion 72 of the second positioning mechanism 70 form an angle of 180° with each other around the axis CL1, they may not be disposed on the reference line SL1.

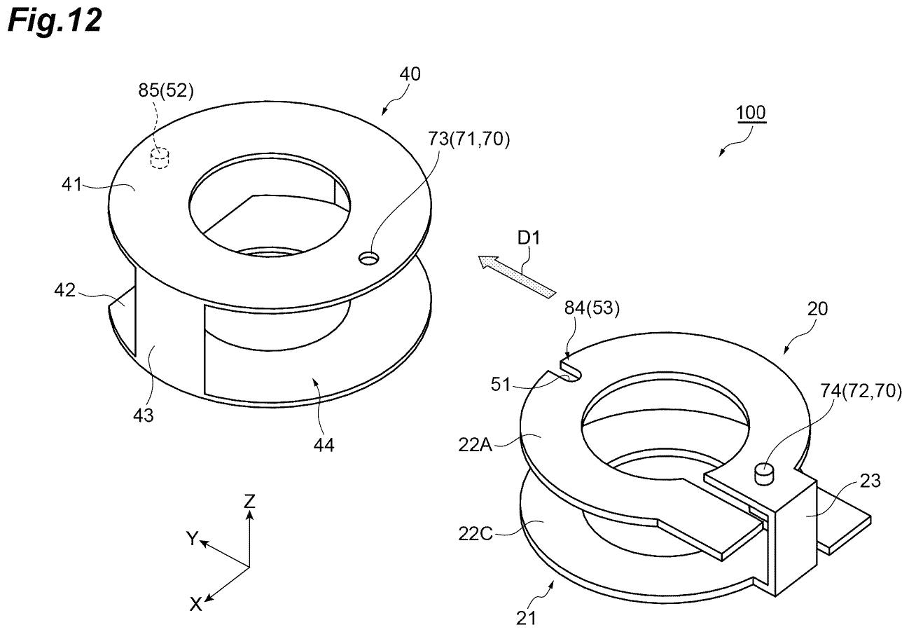

The first positioning mechanism 50 further includes a guide portion 53 for relatively guiding the first engaging portion 52 to the first locking portion 51 along the insertion direction D1 when the coil 20 is inserted into the bobbin 40. When the first locking portion 51 is provided in the bobbin 40 and the first engaging portion 52 is provided in the coil 20, the guide portion 53 is provided in a region of the bobbin 40 on the upper side in the insertion direction D1 with respect to the first locking portion 51. Thus, when the coil 20 is inserted into the bobbin 40, the first engaging portion 52 of the coil 20 can be guided by the guide portion 53 of the bobbin 40 toward the first locking portion 51 existing on the lower side in the insertion direction D1. When the first locking portion 51 is provided in the coil 20 and the first engaging portion 52 is provided in the bobbin 40, the guide portion 53 is provided in a region of the coil 20 on the lower side in the insertion direction D1 with respect to the first locking portion 51 (for example, see FIG. 12). Thus, when the coil 20 is inserted into the bobbin 40, the first engaging portion 52 of the bobbin 40 can be guided by the guide portion 53 of the coil 20 toward the first locking portion 51 existing on the upper side in the insertion direction D1. In this embodiment, the first locking portion 51 and the first engaging portion 52 of the first positioning mechanism 50 and the second locking portion 71 and the second engaging portion 72 of the second positioning mechanism 70 are disposed on the reference line SL1 in a plan view. Accordingly, the guide portion 53 is also disposed on the reference line SL1 in a plan view.

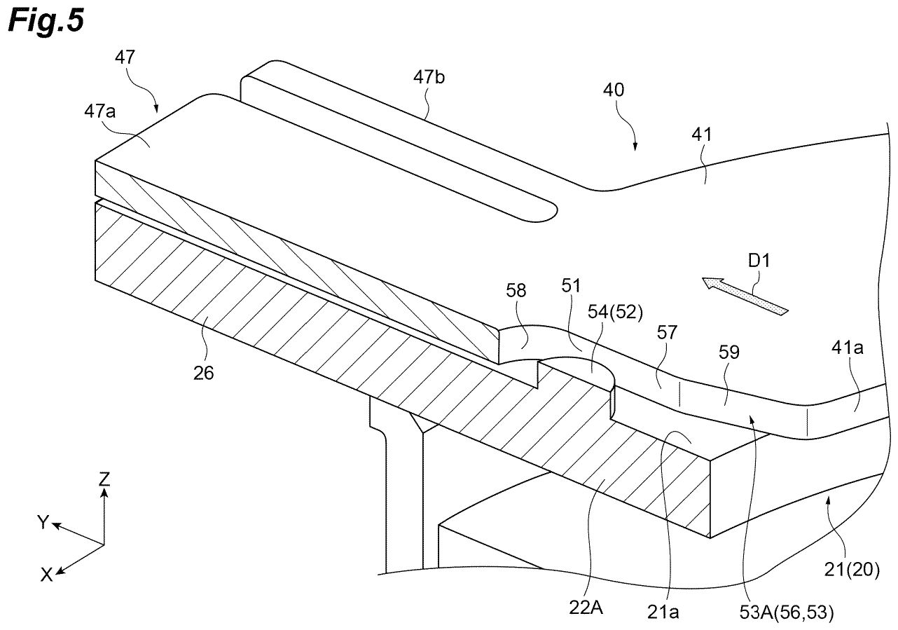

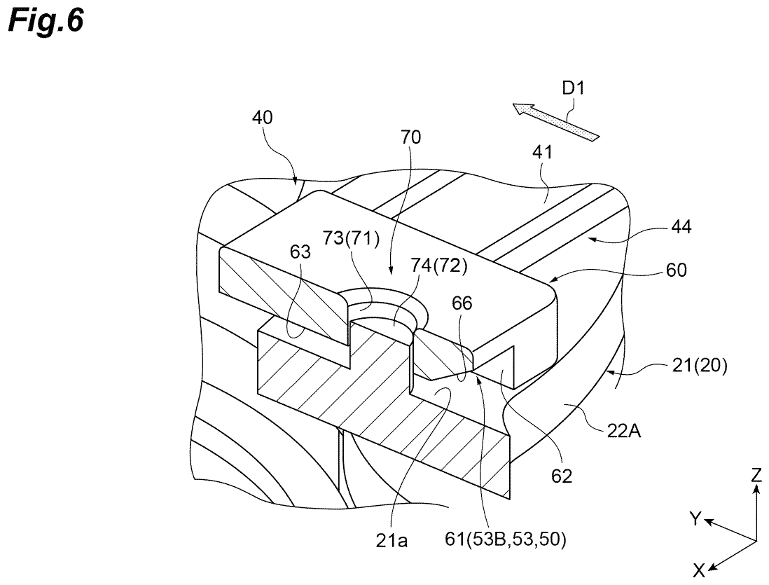

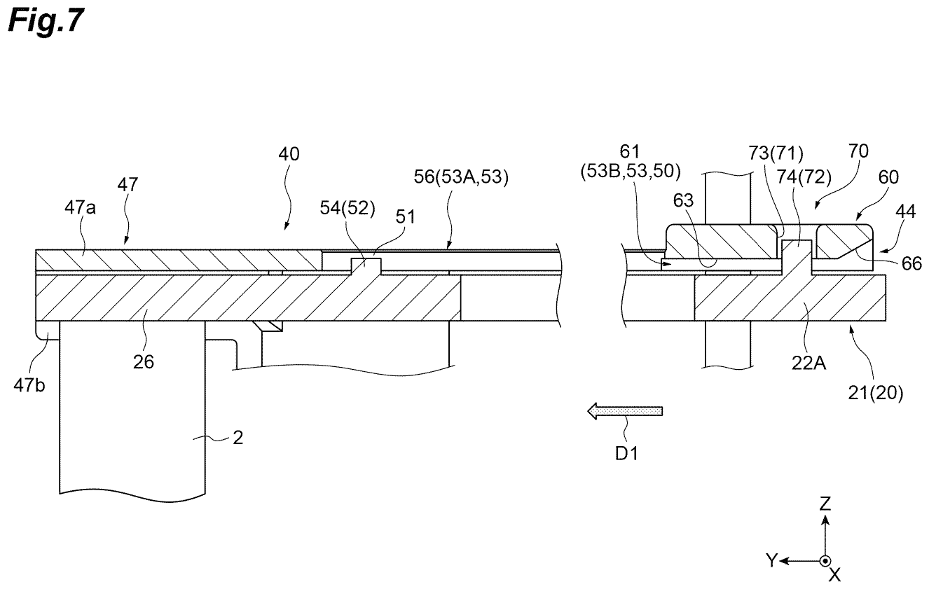

Next, the first positioning mechanism 50 and the second positioning mechanism 70 will be described in more detail with reference to FIGS. 5 to 7 in addition to FIG. 4. FIG. 5 is a cross-sectional perspective view of the first locking portion 51 and the first engaging portion 52. FIG. 6 is a cross-sectional perspective view of the second locking portion 71 and the second engaging portion 72. FIG. 7 is a cross-sectional view taken along line VII-VII of FIG. 4.

As shown in FIG. 5, the first engaging portion 52 is at least one first protruding portion 54 provided on the coil 20 and received by the first locking portion 51 of the bobbin 40. The first protruding portion 54 protrudes upward from the upper main surface 21a of the uppermost winding portion 22A. The first protruding portion 54 is disposed on the reference line SL1 on the main surface 21a of the winding portion 22A on the lower side of the axis CL1 in the insertion direction D1 (see FIG. 4). Note that a plurality of first protruding portions 54 may be provided. As shown in FIG. 4, the first positioning mechanism 50 has a

first guide portion 53A and a second guide portion 53B provided on the bobbin 40. The first guide portion 53A is a guide portion 53 provided on the lower side of the penetration portion 40a in the insertion direction D1, and the second guide portion 53B is a guide portion 53 provided on the upper side of the penetration portion 40a in the insertion direction D1. The first guide portion 53A and the second guide portion 53B have a groove shape extending in the insertion direction D1. The groove shape is a shape having a pair of side surfaces separated from each other in the X-axis direction orthogonal to the insertion direction D1 and extending along the insertion direction D1. The groove shape includes a structure in which the upper sides of the pair of side surfaces are closed by an upper wall (for example, the later-described guide groove 61) and a structure in which the upper sides of the pair of side surfaces are open without being closed (for example, the later-described slit 56). The first guide portion 53A and the second guide portion 53B are arranged in parallel with the insertion direction D1, and extend in parallel with the insertion direction D1. The first guide portion 53A and the second guide portion 53B are disposed on the reference line SL1 in a plan view. Each of the locking portions 51 and 71 and the engaging portions 52 and 72 is provided for either the first guide portion 53A or the second guide portion 53B.

As shown in FIG. 5, the first guide portion 53A has a slit 56 opened in the insertion direction D1. The slit 56 is formed at an end portion of the inner peripheral edge 41a of the upper wall portion 41 of the bobbin 40 on the lower side in the insertion direction D1. The slit 56 is formed by a substantially U-shaped notch extending from the inner peripheral edge 41a along the insertion direction D1 in a plan view (see FIG. 4). The slit 56 penetrates the upper wall portion 41 in the vertical direction. The slit 56 has a pair of side surfaces 57 opposed to each other in the X-axis direction and a bottom portion 58 on the lowest side in the insertion direction D1. As described above, the slit 56 has a groove shape in which the side surfaces 57 opposed to each other in the X-axis direction extend in the insertion direction D1. The pair of side surfaces 57 are connected to each other at a bottom portion 58. The slit 56 has a taper portion 59 whose width increases toward the side into which the first protruding portion 54 is inserted, that is, toward the upper side in the insertion direction D1. The distance between the pair of side surfaces 57 of the taper portion 59 increases from the lower side toward the upper side in the insertion direction D1.

A region of the slit 56 near the bottom portion 58 on the lower side in the insertion direction D1 is configured as a first locking portion 51. The pair of side surfaces 57 serving as the first locking portion 51 receive the first protruding portion 54 so as to sandwich the first protruding portion 54 from both sides in the X-axis direction. Therefore, the first locking portion 51 restricts the movement of the first protruding portion 54 to both sides in the X-axis direction by the pair of side surfaces 57.

As shown in FIG. 4, the upper wall portion 41 of the bobbin 40 has a flat plate portion 60 provided at a central position in the X-axis direction in the opening 44. The flat plate portion 60 is thicker than the upper wall portion 41 at other portions, and extends upward in the insertion direction D1 from the linear edge portion of the opening 44. The flat plate portion 60 is disposed upper of the cores 10A and 10B in the insertion direction D1.

As shown in FIG. 6, the second guide portion 53B has a guide groove 61 formed in the lower surface of the flat plate portion 60. The guide groove 61 has a shape recessed upward from the lower surface of the flat plate portion 60. The guide groove 61 has a pair of side surfaces 62 opposed to each other in the X-axis direction and an upper surface 63. The guide groove 61 is formed over the entire region in the insertion direction D1 of the flat plate portion 60. Therefore, at the time of manufacturing, the first protruding portion 54 inserted into the guide groove 61 from the end portion on the upper side in the insertion direction D1 of the flat plate portion 60 is guided in the insertion direction D1 by the guide groove 61 and comes out from the end portion on the lower side in the insertion direction D1 of the flat plate portion 60.

The flat plate portion 60 has a hole portion 73 at the position of the guide groove 61. The hole portion 73 penetrates from the upper surface 63 of the guide groove 61 to the upper surface of the flat plate portion 60. The second positioning mechanism 70 has a hole portion 73 as the second locking portion 71 for receiving the second engaging portion 72. The hole portion 73 restricts the movement of the accommodated second engaging portions 72 in all directions including both sides in the insertion direction D1 and both sides in the X-axis direction. However, the hole portion 73 only needs to be able to receive the second engaging portion 72, and may be a recess not penetrating to the upper surface side.

The second engaging portion 72 is a second protruding portion 74 provided in the coil 20 and received in the hole portion 73 serving as the second locking portion 71 of the bobbin 40. The second protruding portion 74 protrudes upward from the main surface 21a of the uppermost winding portion 22A. The second protruding portion 74 is disposed on the main surface 21a of the winding portion 22A at a position on the reference line SL1 which is upper side of the axis CL1 in the insertion direction D1 (see FIG. 4).

In the present embodiment, the first protruding portion 54 and the second protruding portion 74 have a cylindrical shape. However, the shapes of the first protruding portion 54 and the second protruding portion 74 are not particularly limited, and may be a polygonal prism such as a quadrangular prism, a cone, a polypyramid, a truncated cone, a truncated polypyramid, or the like.

With the arrangement described above, the first protruding portion 54, which is the first engaging portion 52, is provided on the lower side in the insertion direction D1 of the second protruding portion 74, which is the second engaging portion 72. Similarly, the first locking portion 51 is provided on the lower side in the insertion direction D1 of the hole portion 73 which is the second locking portion 71. The hole portion 73 of the first locking portion 51 and the second locking portion 72 are arranged in parallel with the insertion direction D1. The first protruding portion 54, which is also the first engaging portion 52, and the second protruding portion 74, which is also the second engaging portion 72, are arranged in parallel with the insertion direction D1.

As shown in FIG. 7, the height of the first protruding portion 54 is lower than that of the second protruding portion 74. The hole portion 73 as the second locking portion 71 is disposed at a position higher than the first locking portion 51 that receives the first protruding portion 54. Specifically, the upper surface 63 of the guide groove 61 of the second guide portion 53B is disposed at a position higher than, equal to, or slightly lower than the upper surface of the first protruding portion 54. Therefore, when the first protruding portion 54 is guided by the guide groove 61, the first protruding portion 54 does not come into contact with the upper surface 63 of the guide groove 61, or the movement of the first protruding portion 54 is not hindered even if the first protruding portion 54 comes into contact with the upper surface 63 of the guide groove 61. Further, the first protruding portion 54 does not fit into the hole portion 73 of the second locking portion 71. On the other hand, since the slit 56 having the first locking portion 51 is disposed at a position lower than the hole portion 73 of the second locking portion 71, the first protruding portion 54 can be engaged with the first locking portion 51. The second protruding portion 74 extends to a position higher than the guide groove 64. Therefore, it is fitted into the hole portion 73 of the second locking portion 71. In a plan view, the diameter of the first protruding portion 54 is larger than the diameter of the second protruding portion 74.

An inclined portion 66 is formed at the opening 44 of the bobbin 40. The inclined portion 66 is formed at an end of the flat plate portion 60 on the upper side in the insertion direction D1 of the guide groove 61. The upper surface 63 of the guide groove 61 is inclined upward toward the upper side in the insertion direction D1, thereby forming the inclined portion 66. The inclined portion 66 guides the second protruding portion 74 to smoothly enter the lower side of the flat plate portion 60 when the coil 20 is inserted.

As shown in FIG. 4, the bobbin 40 has a protrusion receiving portion 47 extending in the insertion direction D1 on the side opposite to the opening 44 in the insertion direction D1. The protrusion receiving portion 47 protrudes from the peripheral wall portion 43 on the lower side in the insertion direction D1 toward the lower side in the insertion direction D1. The coil 20 has plate-shaped protruding slip portions 26 extending in the insertion direction D1 at end portions on the lower side in the insertion direction D1 (see FIG. 3). The coil 20 has three protruding slip portions 26 protruding from each of the winding portions 22A, 22B, and 22C. Thus, the bobbin 40 has three protrusion receiving portion 47. The protrusion receiving portion 47 has an upper wall portion 47a and a pair of side wall portions 47b. The pair of side wall portions 47b support the protruding slop portion 26 from both sides in the X-axis direction. Therefore, when the protruding slip portion 26 is received by the protrusion receiving portion 47, the movement of the coil 20 in the X-axis direction orthogonal to the insertion direction D1 with respect to the bobbin 40 is restricted. The protrusion receiving portion 47 can guide the coil 20 through the protruding slip portion 26 when the coil 20 is inserted into the bobbin 40. In this way, the protrusion receiving portion 47 can also function as the first locking portion 51 and the guide portion 53. The protruding slip portion 26 functions as the first engaging portion 52.

As shown in FIGS. 5 and 7, the protrusion receiving portion 47 does not have a wall portion on the lower surface side. Therefore, the protruding slip portion 26 is exposed on the lower surface side. As shown in FIG. 7, the base plate 2 comes into contact with the protruding slip portion 26 exposed from the protrusion receiving portion 47. Thus, the protruding slip portion 26 is thermally connected to the base plate 2. Heat from the coil 20 is radiated through the protruding slip 26 and the base plate 2.

Next, functions and effects of the winding component 100 and the power supply device 1 according to the present embodiment will be described.

In the winding component 100 according to the present embodiment, the first positioning mechanism 50 has the first locking portion 51 provided on one of the bobbin 40 and the coil 20, and the first engaging portion 52 provided on the other of the bobbin 40 and the coil 20 and engaged with the first locking portion 51. Therefore, when the first engaging portion 52 is engaged with the first locking portion 51, the first positioning mechanism 50 performs positioning. The second positioning mechanism 70 includes the second locking portion 71 provided on one of the bobbin 40 and the coil 20, and the second engaging portion 72 provided on the other of the bobbin 40 and the coil 20 and engaged with the second locking portion 71. Therefore, when the second engaging portion 72 is engaged with the second locking portion 71, the second positioning mechanism 70 performs positioning. In this way, positioning can be performed at a plurality of positions by the first positioning mechanism 50 and the second positioning mechanism 70. Further, the second positioning mechanism 70 has the hole portion 73 for receiving the second engaging portion 72 as the second locking portion 71. By engaging the second engaging portion 72 with the hole portion 73, the second positioning mechanism 70 can restrict the displacement between the bobbin 40 and the coil 20 over the entire circumference. Thus, the bobbin 40 and the coil 20 can be accurately positioned. On the other hand, the first positioning mechanism 50 includes the guide portion 53 for relatively guiding the first engaging portion 52 to the first locking portion 51 along the insertion direction D1 when the coil 20 is inserted into the bobbin 40. Therefore, when the coil 20 is inserted into the bobbin 40, the coil 20 can be easily positioned only by moving the coil 20 along the guide portion 53. As described above, the bobbin 40 and the coil 20 can be accurately positioned while enabling easy manufacturing.

The guide portion 53 of the first positioning portion 50 may have a groove shape extending in the insertion direction D1. In this case, the first locking portion 51 is smoothly guided in the insertion direction D1 along the groove shape of the guide portion 53. Therefore, the coil 20 can be easily inserted into the bobbin 40.

The first engaging portion 52 may be provided on the lower side of the second engaging portion 72 in the insertion direction D1. In this case, when the coil 20 is inserted into the bobbin 40, the first engaging portion 52 is guided by the guide portion 53 prior to the second engaging portion 72. As a result, in addition to the smooth positioning by the first positioning mechanism 50, the positioning by the second positioning mechanism 70 can also be performed smoothly. Further, the moving distance of the second engaging portion 72 from the point where the bobbin 40 and the coil 20 are overlapped at the position of the second engaging portion 72 to the point where the bobbin 40 and the coil 20 reach the hole portion 73 of the second locking portion 71 can be made shorter (than that of the first engaging portion 52). Therefore, the distortion of the bobbin 40 and the coil 20 can be reduced.

The first engaging portion 52 may be at least one first protruding portion 54 provided in the coil 20 and received by the first locking portion 51 of the bobbin 40, and the second engaging portion 72 may be a second protruding portion 74 provided in the coil 20 and received by the hole portion 73 as the second locking portion 71 of the bobbin 40. As described above, since both of the first engaging portion 52 and the second engaging portion 72 are the first protruding portion 54 and the second protruding portion 74 provided in the coil 20, the guide portion 53 and the hole portion 73 can be provided on the bobbin 40 side having a high degree of freedom in shape. In addition, since the first engaging portion 52 is the first protruding portion 54, a smooth guide can be achieved with a simple structure. Since the second engaging portion 72 is the second protruding portion 74, it can be smoothly inserted into the hole portion 73 of the second locking portion 71. Therefore, the coil 20 can be easily inserted into the bobbin 40.

The first protruding portion 54 and the second protruding portion 74 are provided on the one main surface 21a side of the coil 20, and the height of the first protruding portion 54 may be lower than that of the second protruding portion 74. In this case, it is possible to prevent the first protruding portion 54 from interfering with the structure near the second locking portion 71 for engaging with the second protruding portion 74. Therefore, the coil 20 can be easily inserted into the bobbin 40. Moreover, the distortion of the bobbin 40 and the coil 20 can be reduced.

The hole portion 73 serving as the second locking portion 71 may be disposed at a position higher than the first locking portion 51 receiving the first protruding portion 54. In this case, the first protruding portion 54 can be prevented from being erroneously inserted into the hole portion 73 serving as the second locking portion 71. Therefore, the coil 20 can be easily inserted into the bobbin 40. Further, by suppressing the interference between the first protruding portion 54 and the hole portion 73, the distortion of the bobbin 40 and the coil 20 can be reduced.

In a plan view, the diameter of the first protruding portion 54 may be larger than the diameter of the second protruding portion 74. In this case, erroneous insertion into the hole portion 73 of the second locking portion 71 can be suppressed. Therefore, the coil 20 can be easily inserted into the bobbin 40.

The inclined portion 66 may be formed in the opening 44 of the bobbin 40. In this case, in the opening 44 of the bobbin 40, the first engaging portion 52 and the second engaging portion 72 are smoothly guided in the insertion direction D1 by the inclined portion 66. Therefore, the coil 20 can be easily inserted into the bobbin 40. Further, the distortion of the bobbin 40 and the coil 20 can be reduced by the smooth insertion.

The first locking portion 51 and the second locking portion 71 may be arranged in parallel with the insertion direction D1. In this case, when inserting the coil 20 into the bobbin 40, the coil 20 can be easily inserted into the bobbin 40 by aligning the first locking portion 51 and the second locking portion 71 so that they are aligned in parallel with the insertion direction D1.

The first positioning mechanism 50 may have, as the guide portion 53, a slit 56 that opens in the insertion direction D1, and the slit 56 may have a taper portion 59 that widens toward the side where the first engaging portion 52 is inserted. In this case, the taper portion 59 of the slit 56 can receive the inserted first engaging portion 52 and guide the first engaging portion 52 to the first locking portion 51. Therefore, the coil 20 can be easily inserted into the bobbin 40. Further, the distortion of the bobbin 40 and the coil 20 can be reduced by the smooth insertion.

The bobbin 40 has a protrusion receiving portion 47 extending in the insertion direction D1 on the side opposite to the opening 44 in the insertion direction D1, the coil 20 has a protruding slip portion 26 extending in the insertion direction D1 at the end on the lower side in the insertion direction D1, and the protruding slip portion 26 is received by the protrusion receiving portion 47, whereby the movement of the coil 20 with respect to the bobbin 40 in the direction orthogonal to the insertion direction D1 may be restricted. In this case, when the coil 20 is inserted into the bobbin 40, the coil 20 can be inserted while being guided by the protrusion receiving portion 47 in a state where the protruding slip portion 26 is inserted into the protrusion receiving portion 47. Therefore, the coil 20 can be easily inserted into the bobbin 40. Further, the protruding slip portion 26 can have a heat radiation function of the coil 20.

The power supply device 1 according to the present embodiment includes the winding component 100 and the base plate 2 supporting the winding component 100, and uses the winding component 100 in a voltage conversion circuit.

According to the power supply device 1, the winding component 100 described above can be suitably used in the power supply device 1.

The coil 20 has a protruding slip portions 26 extending in the insertion direction D1 at end portions on the lower side in the insertion direction D1, and the protruding slip portion 26 may be thermally connected to the base plate 2. In this case, the heat of the coil 20 can be suitably radiated through the protruding slip portion 26 and the base plate 2.

The present disclosure is not limited to the embodiments described above.

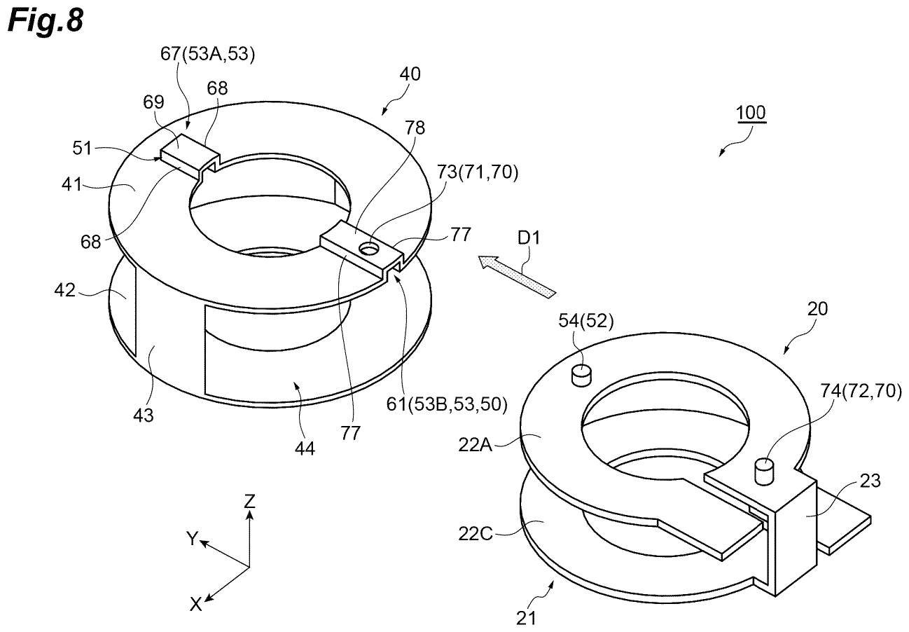

For example, the configuration shown in FIG. 8 may be adopted. The coil 20 of the winding component 100 shown in FIG. 8 has winding portions 22A and 22C, and has two turns. The winding portions 22A and 22C are connected via a relay portion 23. The upper wall portion 41 and the lower wall portion 42 of the bobbin 40 are substantially annular flat plate members as a whole. In the configuration shown in FIG. 8, the structure around the second guide portion 53B is different from that of the above-described embodiment. In the configuration shown in FIG. 8, the guide groove 61 of the second guide portion 53B includes a pair of side wall portions 77 rising upward and an upper wall portion 78 closing the upper side of the side wall portions 77. The first guide portion 53A has the guide groove 67. The guide groove 67 includes a pair of side wall portions 68 rising upward, and an upper wall portion 69 closing the upper side of the side wall portions 68. The pair of side wall portions 68 of the guide groove 67 constitute the first locking portion 51.

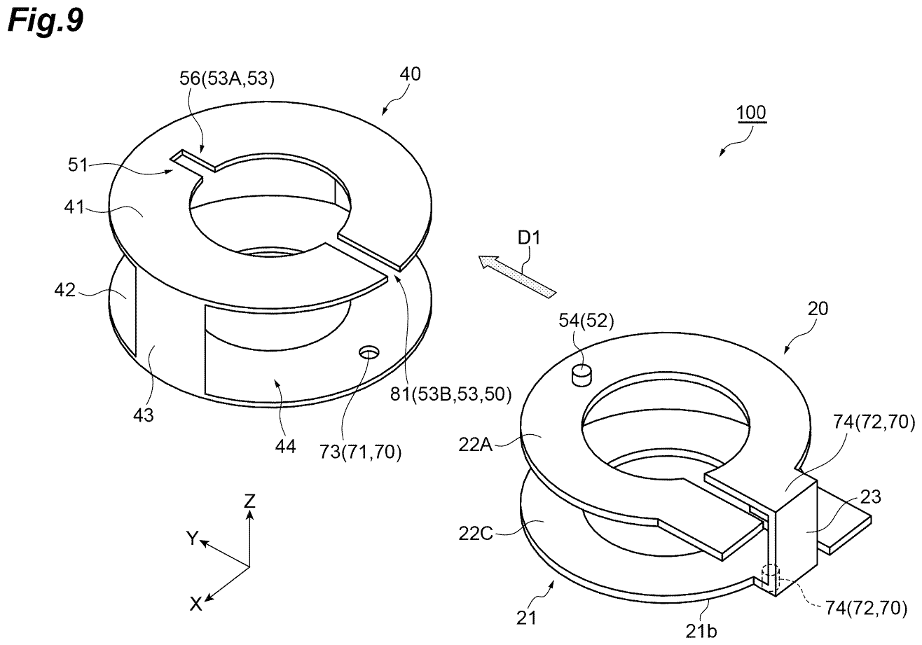

The configuration shown in FIG. 9 may also be employed. The bobbin 40 of the winding component 100 shown in FIG. 9 has a slit 56 as the first guide portion 53A. The bobbin 40 also has a slit 81 as the second guide portion 53B. The slit 81 penetrates from the outer peripheral edge to the inner peripheral edge at the end of the upper wall portion 69 on the upper side in the insertion direction D1. Therefore, at the time of manufacturing, the first protruding portion 54 can move to the lower side in the insertion direction D1 while being guided by the slit 81. Here, the slit 81 cannot be provided with the hole portion 73 of the second locking portion 71. Accordingly, the hole portion 73 of the second locking portion 71 is provided in the lower wall portion 42. Accordingly, the second protruding portion 74 of the second engaging portion 72 of the coil 20 is provided on the lower main surface 21b of the lower winding portion 22C. As described above, the second locking portion 71 and the second engaging portion 72 may be provided at positions away from the guide portion 53.

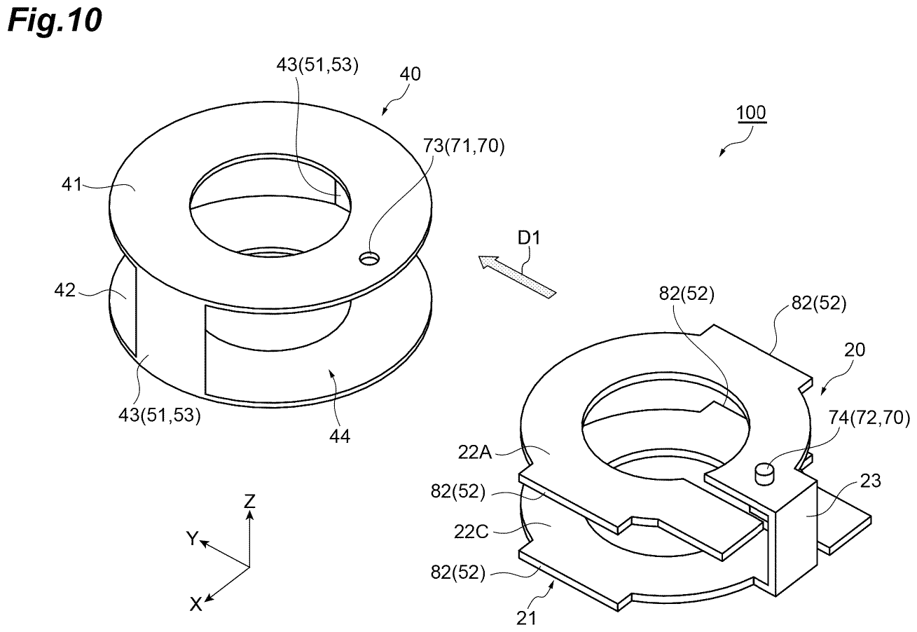

Further, the configuration shown in FIG. 10 may be adopted. The bobbin 40 of the winding component 100 shown in FIG. 10 does not have the groove-shaped guide portion 53, and does not have the first guide portion 53A and the second guide portion 53B. Further, the bobbin 40 does not have the first locking portion 51 provided in the groove-shaped guide portion 53. Accordingly, the coil 20 does not have the first protruding portion 54 as the first engaging portion 52. Instead, the bobbin 40 causes the peripheral wall portions 43 on both sides in the X-axis direction to function as the guide portion 53 and the first locking portion 51. The coil 20 causes guided portions 82, which project outward to the outer peripheral side on both sides of the winding portions 22A and 22C in the X-axis direction, to function as the first engaging portion 52. The guided portion 82 has an edge portion parallel to the insertion direction D1. When the coil 20 is inserted into the bobbin 40 from the opening 44 during manufacturing, the guided portion 82 of the coil 20 is sandwiched between the peripheral wall portions 43 from both sides in the X-axis direction, and is inserted into the bobbin 40 while being guided in the insertion direction D1 by the peripheral wall portions 43. After the insertion is completed, the movement of the guided portions 82 of the coil 20 in the X-axis direction is restricted by the peripheral wall portions 43. Since the second guide portion 53B is not provided, the hole portion 73 of the second locking portion 71 is provided in the upper wall portion 41. Such a structure is effective when it is not desired to make holes in the winding portions 22A and 22B of the coil 20.

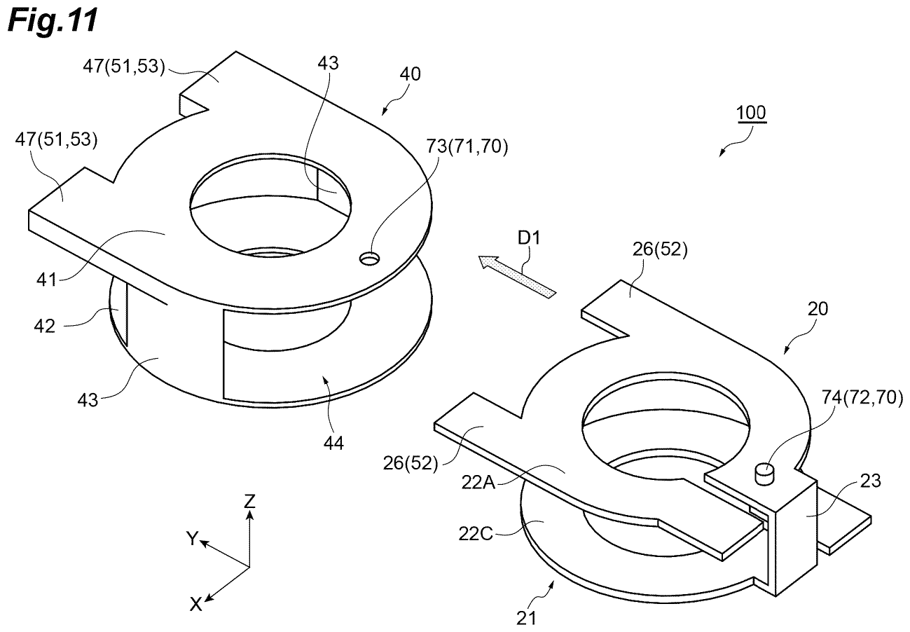

The configuration shown in FIG. 11 may also be employed. In the structure shown in FIG. 11, the protrusion receiving portion 47 of the bobbin 40 functions as the first locking portion 51 and the guide portion 53. The protruding slip portion 26 of the coil 20 is made to function as the first engaging portion 52. The pair of protrusion receiving portions 47 are provided on both sides in the X-axis direction of the end portion on the lower side in the insertion direction D1 of the upper wall portion 41. The pair of protruding slips 26 are provided on both sides in the X-axis direction of the end portion on the lower side in the insertion direction D1 of the upper winding portion 22A. The other structures are the same as those of the protrusion receiving portion 47 and the protruding slip portion 26 according to the above-described embodiment. Therefore, by thermally connecting the base plate 2 to the lower surface of the protruding slip portion 26, heat can be radiated. Such a structure is effective in providing a heat radiation effect to the base plate 2 when it is not desired to make a hole or the like in the winding portions 22A and 22B of the coil 20.

The configuration shown in FIG. 12 may also be employed. In the configuration shown in FIG. 12, the coil 20 has the first locking portion 51 and the guide portion 53, and the bobbin 40 has the first engaging portion 52. The slit 84 provided in the coil 20 functions as the guide portion 53 and the first locking portion 51. The slit 84 is provided at the end of the winding portion 22A on the lower side in the insertion direction D1. The slit 84 extends from the outer peripheral edge of the winding portion 22A to the upper side in the insertion direction D1. The protruding portion 85 provided on the bobbin 40 functions as the first engaging portion 52. The protruding portion 85 is provided in a region of the lower surface of the upper wall portion 41 on the lower side in the insertion direction D1. The protruding portion 85 protrudes downward from the lower surface of the upper wall portion 41. When the coil 20 is inserted from the opening 44 in the insertion direction D1 of the bobbin 40, the protruding portion 85 enters the slit 84. As a result, the protruding portion 85 is relatively moved toward the first locking portion 51 while being guided by the slit 84. After the manufacturing is completed, movement of the protruding portion 85 in the X-axis direction is restricted by the side surfaces on both sides of the slit 84. Such a structure is effective in avoiding the provision of the protruding portion in the winding portion 22A.

In the above-described embodiment, the engaging portion, the engaging portion, and the guide portion are provided in a region that does not overlap the cores 10A and 10B, but may be provided in a region that overlaps the cores 10A and 10B. In this case, the insulating distance between the cores 10A, 10B and the structure may be ensured.

The coil 20 may be provided with the hole portion 73 of the second locking portion 71, and the bobbin 40 may be provided with the second protruding portion 74 of the second engaging portion 72. In this case, in order to prevent the volume of the winding portion from decreasing and affecting the coil characteristics, a slip portion extending outward from the winding portion may be provided, and the hole portion 73 may be provided in the slip portion.

What is claimed is:

1. A winding component comprising:
a core;
a plate-shaped coil provided with regard to the core;
a bobbin housing the coil; and
a first positioning mechanism and a second positioning mechanism for positioning the bobbin and the coil relative to each other,
wherein the bobbin has an opening, the coil is insertable in an insertion direction through the opening in manufacturing;
wherein the first positioning mechanism has a first locking portion provided on one of the bobbin and the coil and a first engaging portion provided on the other of the bobbin and the coil and engaging the first locking portion;
wherein the second positioning mechanism has a second locking portion provided on one of the bobbin and the coil and a second engaging portion provided on the other of the bobbin and the coil and engaging the second locking portion;
wherein the first positioning mechanism further has a guide portion guiding the first engaging portion along the insertion direction toward the first locking portion when the coil is inserted into the bobbin; and
wherein the second positioning mechanism has a hole portion receiving the second engaging portion, as the second locking portion.

2. The winding component according to claim 1, wherein the guide portion of the first positioning mechanism has a groove shape extending in the insertion direction.

3. The winding component according to claim 1, wherein the first engaging portion is provided on lower side in the insertion direction relative to the second engaging portion.

4. The winding component according to claim 1, wherein the first engaging portion is at least one first protruding portion provided on the coil and received by the second locking portion of the bobbin, and the second engaging portion is a second protruding portion provided on the coil and received by the hole portion serving as the second locking portion of the bobbin.

5. The winding component according to claim 4, wherein the first protruding portion and the second protruding portion are provided on one main surface side of the coil, and the first protruding portion has a height lower than a height of the second protruding portion.

6. The winding component according to claim 5, wherein the hole portion serving as the second locking portion is located at a position higher than the first locking portion receiving the first protruding portion.

7. The winding component according to claim 4, wherein, in a plan view, a diameter of the first protruding portion is larger than a diameter of the second protruding portion.

8. The winding component according to claim 1, wherein an inclined portion is formed at the opening of the bobbin.

9. The winding component according to claim 1, wherein the first locking portion and the second locking portion are arranged parallel to the insertion direction.

10. The winding component according to claim 1, wherein the first positioning mechanism has a slit, as the guide portion, opening toward the insertion direction, and the slit has a taper portion widening on a side into which the first engaging portion is inserted.

11. The winding component according to claim 1, wherein the bobbin has a protrusion receiving portion extending in the insertion direction on a side opposite to the opening in the insertion direction, the coil has a protruding slip portion extending in the insertion direction at a lower end in the insertion direction, and movement of the coil in a direction orthogonal to the insertion direction relative to the bobbin is restricted by the protruding slip portion being received in the protrusion receiving portion.

12. A power supply device comprising the winding component according to claim 1 and a base plate supporting the winding component, wherein the winding component is used in a voltage conversion circuit.

13. The power supply device according to claim 12, wherein the coil has a protruding slip portion extending in the insertion direction at a lower end in the insertion direction, and the protruding slip portion is thermally connected to the base plate.
